(19) United States
(12) Patent Application Publication
(10) Pub. No.: US 2002/0172420 A1
(43) Pub. Date: Nov. 21, 2002

(54) Image processing apparatus for and method of improving an image and an image display apparatus comprising the image processing apparatus

(76) Inventor: Marina Marie Pierre Nicolas, Le Fontanil (FR)

Correspondence Address: U.S. Philips Corporation, 580 White Plains Road, Tarrytown, NY, 10591, US

(21) Appl. No.: 10/124,063

(22) Filed: Apr. 17, 2002

(30) Foreign Application Priority Data
Apr. 20, 2001 (EP) 01201436.1

(51) Int. Cl. G06K 9/00

(52) U.S. Cl. 382/170; 382/173

(57) ABSTRACT

An image processing apparatus (100) for improving images depending on the type of regions within the image, comprises a segmentation unit (102) to localize regions with a pre-selected type and an improvement unit (106) being designed to improve the image, which can be controlled in order to modulate the amount of improvement over the image. The image processing apparatus (100) further comprises a determination unit to find a range of values to characterize the pixels of the regions which should be handled separately based on the results of the segmentation unit (102).

The invention relates to an image processing apparatus for improving an image, which image comprises a plurality of pixels, and the image processing apparatus comprising:

a segmentation unit that is designed to perform:

a first test whether a first value of a first property of a selected pixel is substantially equal to a second value of a first predetermined range of values of the first property; and

a second test whether a third value of a second property of the selected pixel is substantially equal to a fourth value of a second predetermined range of values of the second property, in order to segment the image into multiple regions of pixels, each region with a region type; and

an improvement unit that is designed to improve the image by processing a particular pixel, depending on the region type of the region to which the particular pixel corresponds.

The invention further relates to an image display apparatus provided with:

receiving means for receiving a video signal representing images;

such an image processing apparatus;

a display device for displaying the images.

The invention further relates to a method of improving an image, which image comprises a plurality of pixels, the method comprising:

a segmentation step to perform:

a first test, being a check whether a first value of a first property of a selected pixel is substantially equal to a second value of a first predetermined range of values of the first property; and

a second test, being a check whether a third value of a second property of the selected pixel is substantially equal to a fourth value of a second predetermined range of values of the second property, in order to segment the image into multiple regions of pixels, each region with a region type; and

an improvement step to improve the image to improve the image by processing a particular pixel, depending on the region type of the region to which the particular pixel corresponds.

An image processing apparatus and a method of the kind described in the opening paragraph are disclosed in U.S. Pat. No. 5,848,181.

The known apparatus provides location dependent noise reduction. The known apparatus varies the amount of noise reduction over the image: a relatively high noise reduction in some regions and a lower noise reduction in other regions. This modulation is to avoid that details are removed by noise reduction. The level of noise reduction required in flat, low detailed, regions is often too high for detailed regions of the same image. Such a high level of noise reduction might result in loss of information. It might also lead to images looking unnatural. There is no reason why the amount of white noise would differ from one region of the image to the other. However, a particular amount of noise is more visible in a flat region of the image than in another, detailed region. In order to achieve an appropriate location dependent noise reduction, a kind of segmentation or classification is required to divide an image into regions which are relatively flat respectively in regions which are more crispy. In the known image processing apparatus the segmentation of the image into regions is based on differences in luminance values of neighboring pixels. The differences in luminance values are used to determine pixel-position dependent coefficients. The noise reduction is then modulated taking into account the pixel-position dependent coefficients. A disadvantage of this known apparatus is that it is very difficult, or even impossible to implement it for real time applications without making use of an image memory and optionally complicated motion-compensation algorithms, which makes it costly. Another disadvantage is that the known apparatus is very sensitive to the segmentation precision with the risk of having artifacts at object borders. E.g. suppose there is an image comprising grass with some small flowers in it. From a segmentation point of view it might be that one grass region is detected. But the isolated pixels corresponding to the small flowers are not segmented separately although they have conditions different from the typical grass conditions. In this case, green enhancement might be required to the surrounding pixels, but not to the isolated pixels.

It is a first object of the invention to provide an image processing apparatus of the kind described in the opening paragraph which is arranged to perform non-position controlled image improvement.

It is a second object of the invention to provide an image display apparatus of the kind described in the opening paragraph comprising an image processing apparatus in which the improvement is not position controlled.

It is a third object of the invention to provide a method of the kind described in the opening paragraph in which the improvement is not position controlled.

The first object of the invention is achieved in that the image processing apparatus comprises a determination unit that is designed to characterize pixels corresponding to regions with a pre-determined region type by determination of an actual range of values of a particular property of the pixels, other than a location; and that the improvement unit processes the pixels corresponding to regions with the pre-determined region type differently. The determination unit is designed to determine for the image under consideration the actual range of values of a property of the pixels which should be handled separately. The particular property may be equal to the first or second property. The determination unit allows to de-couple the segmentation unit from the improvement unit.

For instance the segmentation unit can be placed basically at any place in the processing chain, provided that no improvement feature, placed before it will significantly affect the properties considered for the pre-determined region type. By de-coupling it is not meant that the segmentation unit is completely independent from the improvement unit. The segmentation unit in combination with the determination unit identifies conditions, or range of values, that will require a specific setting in the improvement unit, rather than a specific object. Basically, the improvement unit does not need to know what the picture is representing, but the conditions for which a separate setting is required to avoid non-optimal performance.

A major advantage of the de-coupling between segmentation unit and the improvement unit caused by the determination unit is that it enables a relatively easy real-time implementation of the image processing apparatus. In the case of a sequence of images to be processed use can be made of the temporal continuity of the video signal representing the sequence of images. By temporal continuity it is meant that the conditions that will characterize one region will hardly change from one image to the other. In that case a segmentation can be performed on an image and the results of this segmentation can be used, after translation to condition data, without performing motion compensation, in order to apply an improvement on a subsequent image. In stead of images, i.e. video frames also video fields can be taken as entities for this substitution. By using coordinates to indicate pixels belonging to a region, this is hardly possible, because it is very likely that an object which is computed at pixel position (x,y) within the image as present in the segmentation unit has moved to another position in the improvement unit. For instance, grass pixels might move from one location in the first image to another location in the subsequent image, but it is very likely that the conditions that make them grass in one image, e.g. the value of the color and the luminance gradient around the pixel, will remain nearly unchanged in the next image. Therefor the image processing apparatus does not require precise motion compensation. Another advantage is that the location of the image processing apparatus within the chain of processing units of an image display apparatus is less dependent of the architecture of the image display apparatus. It is even possible that the segmentation unit and the improvement unit are allocated in different parts of the image display apparatus. E.g. the segmentation unit in the begin of the processing chain, followed by some other processing units and then the improvement unit or with improvement units spread over the whole video path. A major other advantage of the system is that, while the segmentation can be made rather sophisticated, the conditions transmitted to the improvement units can be most of the time heavily simplified. For instance, to identify grass, the segmentation unit needs to take into account color and texture information. But, for a given image, if it turns out, at the output of the determination unit that all the green pixels in the picture do have the texture of grass, then the improvement unit only needs to check whether the pixel is green or not.

In an embodiment of the image processing apparatus according to the invention the improvement unit is designed to reduce noise in the image. The rationale for regional noise reduction is explained: to avoid that details are removed by noise reduction and to remove sufficiently noise in flat regions. This enables to modulate the amount of noise reduction over regions of the image. Several types of noise reduction can be realized: e.g. spatial, temporal and spatio-temporal. For a temporal or spatio-temporal noise reduction a sequence of images is required. For both the classification and the noise reduction it is possible to use more than one image.

In an embodiment of the image processing apparatus according to the invention the improvement unit is designed to enhance details in the image. Details may be edges or textures.

In an embodiment of the image processing apparatus according to the invention the first predetermined range of values comprises the values related to color. Knowledge of the scene which has been imaged, makes it possible to extract describing parameters. In the case that it is known that e.g. a football match has been imaged, then it is quite certain that grass will be visible in the images. Because the predetermined range of color values of the image processing apparatus can correspond to the colors of grass this embodiment can be tuned to specific types of scenes. Embodiments with another predetermined range of color values can be tuned to other specific types of scenes, e.g. blue sky, blue water, brown sand, white snow or flesh-tone for human skin.

In an embodiment of the image processing apparatus according to the invention the first test is to verify whether a difference between a first value of the first property of the selected pixel and a ninth value of the neighboring pixel is substantially equal to a value of a third predetermined range of values of the first property. E.g. differences in luminance values are related to the spectrum of frequency components of the image. This spectrum offers a lot of information about noise and hence can be applied to detect noise.

An embodiment of the image processing apparatus according to the invention comprises:

a histogram generating means for generating a histogram of values of the particular property, whereby the histogram comprises pixels for which the first test and the second test are positive;

an analyzer designed to analyze the histogram in order to determine a classification value of the pixels of the image based on the histogram, with the classification value to control the amount of improvement.

The classification values are determined by analyzing the properties of the histogram:

If the histogram is relatively narrow and symmetrical, then the probability that the pixels of the histogram correspond to a region with a pre-selected region type is relatively high;

If the histogram is relatively spread over a large range of values or is unsymmetrical, then the probability that the pixels of the histogram correspond to a region with a pre-selected region type is relatively low.

After having analyzed the histogram the analyzer classifies the pixels. This classification resembles the probability that the pixels of the image meeting the conditions of the tests, correspond to a region with a pre-selected region type. Pixels with mutually substantially equal values get the same classification value. By varying the classification values the amount of image improvement can not only be controlled region by region but even with a lower granularity.

In an embodiment of the image processing apparatus according to the invention comprising the histogram generating means, a maximum classification value corresponds to a center of the actual range, and a minimum classification value corresponds to a border of the actual range, the classification value varying substantially continuously from the center of the actual range towards the border of the actual range. This classification “profile” is based on the following assumptions:

The probability that a pixel at the center of a region has a value which is substantially equal to the value at the center of the actual range is maximum;

The probability that a pixel at a border of a region has a value which is substantially equal to the value at a border of the actual range is minimum;

When moving from the center of a region to the border of the region, the luminance, color and basic gradient values also change monotonously and quite continuously from typical values to border values.

The second object of the invention is achieved in that the image display apparatus comprises an image processing apparatus with a determination unit that is designed to characterize pixels corresponding to regions with a pre-determined region type by determination of an actual range of values of a particular property of the pixels, other than a location; and that the improvement unit processes the pixels corresponding to regions with the pre-determined region type differently.

The third object of the invention is achieved in that the method comprises a determination step to characterize pixels corresponding to regions with a pre-determined region type by determination of an actual range of values of a particular property of the pixels, other than a location; and that the improvement unit processes the pixels corresponding to regions with the pre-determined region type differently.

These and other aspects of the image processing apparatus, the method of improving an image and of the image display apparatus according to the invention will become apparent from and will be elucidated with reference with respect to the implementations and embodiments described hereinafter and with reference to the accompanying drawings, wherein:

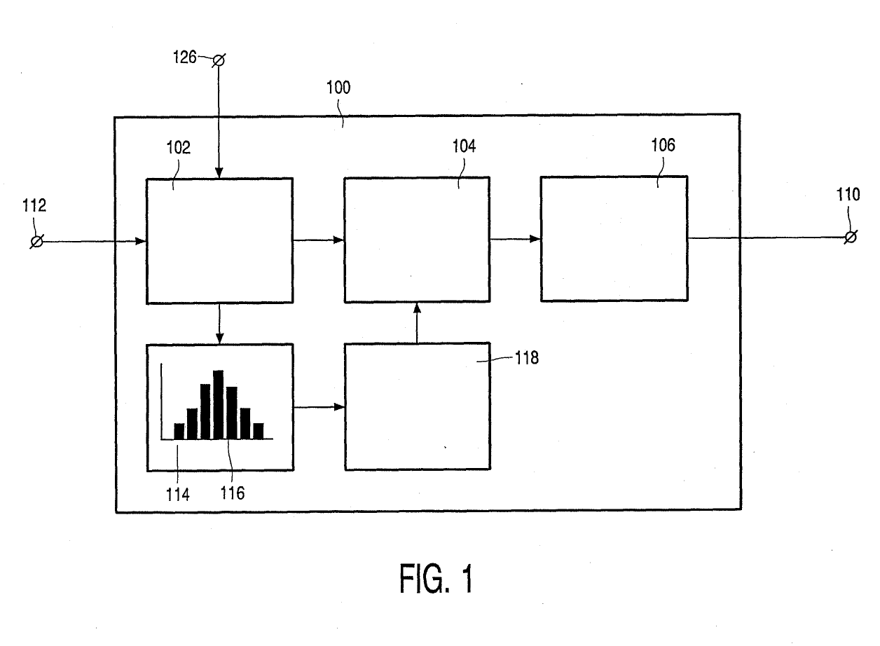

FIG. 1 schematically shows elements of the image processing apparatus;

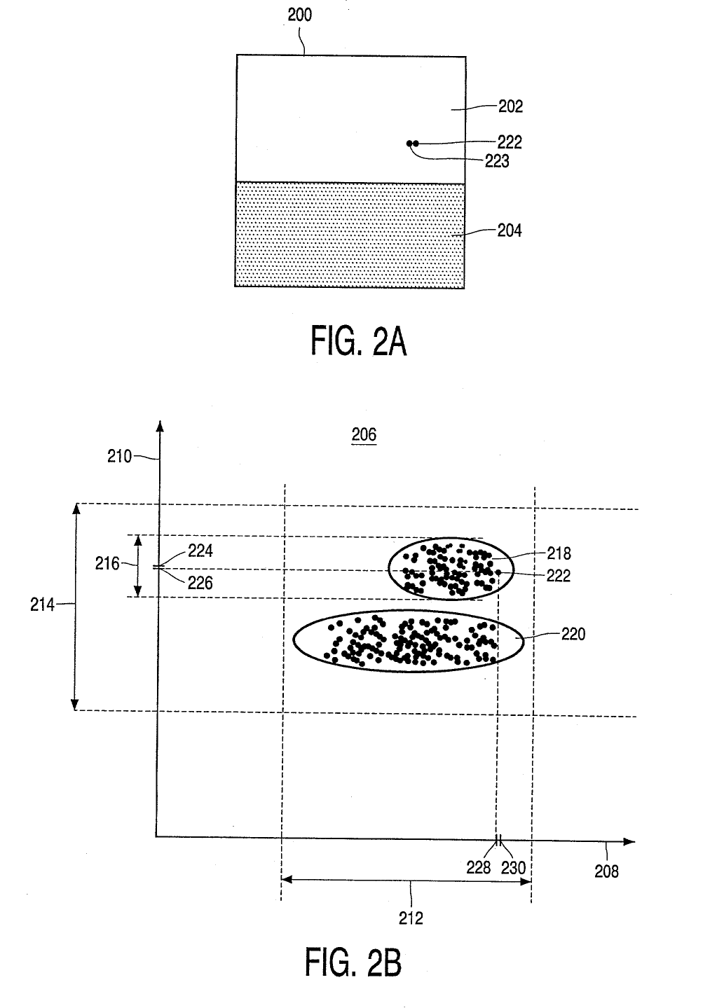

FIG. 2A schematically shows an image with two regions;

FIG. 2B schematically shows a probability space;

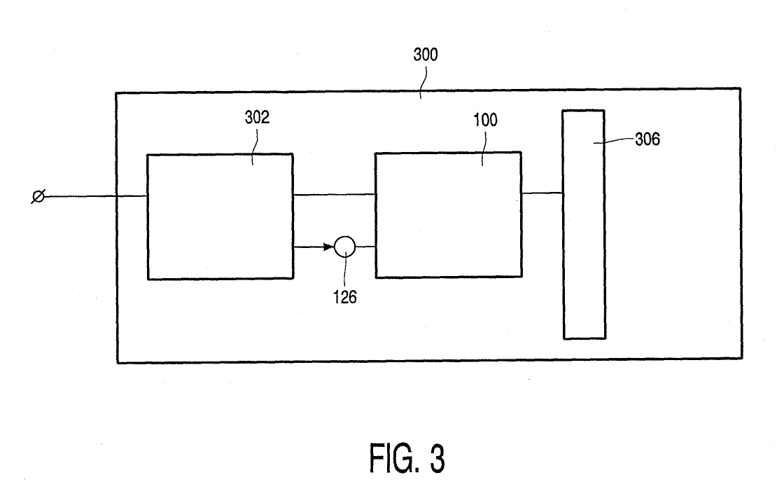

FIG. 3 schematically shows elements of the image display apparatus;

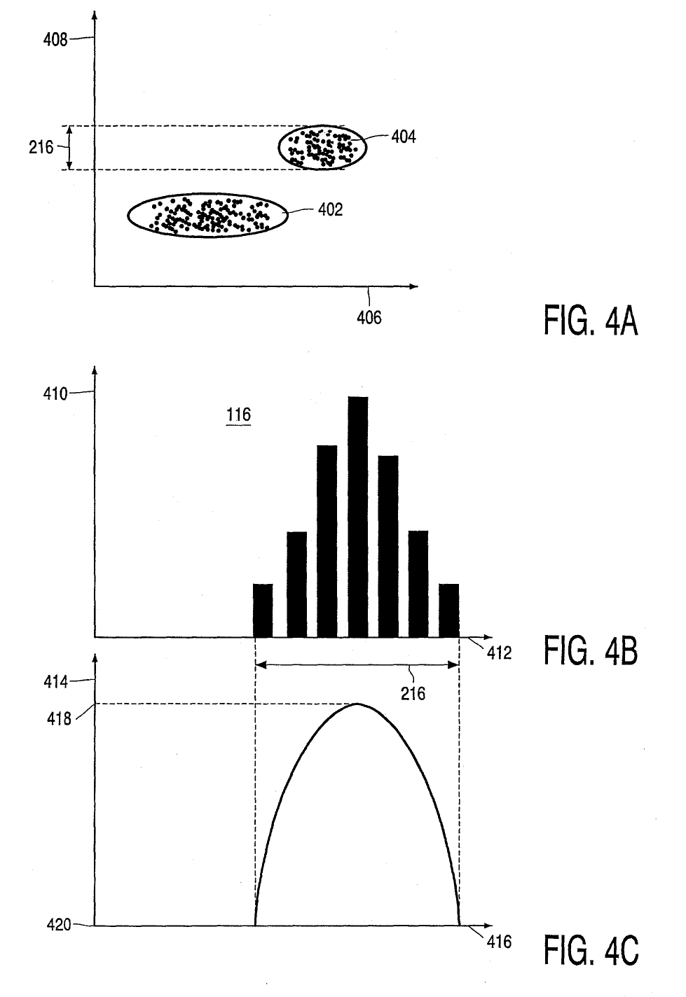

FIG. 4A schematically shows a probability space;

FIG. 4B schematically shows a histogram of pixels; and

FIG. 4C schematically shows a classification function.

FIG. 1 schematically shows the following elements of the image processing apparatus 100:

a segmentation unit 102 that is designed to perform a number of tests in order to segment the image into multiple regions of pixels, each region with a region type;

a determination unit 104 that is designed to determine an actual range of values, in order to be able to indicate the region type of the region to which the selected pixel corresponds;

an improvement unit 106 that is designed to improve the image by processing the pixels, depending on the region type of the region to which the pixels correspond;

a histogram generating means 114 for generating a histogram 116 of values of the particular property, whereby the histogram comprises pixels for which the tests are positive; and

an analyzer 118 designed to analyze the histogram 116 in order to determine a classification value of the pixels of the image based on the histogram 116.

The image enters the image processing apparatus 100 at the input connector 112. Improved image is provided at the output connector 110. The predetermined ranges of values for the tests in the segmentation unit 102 can be adjusted by means of the control input 126. The segmentation unit 102 may use simple pixel-based tests, but also much more complicated ones like block-based, i.e. texture related tests are possible. The output of the segmentation unit contains either condition information directly or, if e.g. concealment is used in the segmentation, location information P(x,y) which represents the probability of the pixel at location (x,y) to belong to a particular region. However the goal of the segmentation unit 102 in combination with determination unit 104 is not to identify the location of objects, but to determine whether there are regions in the image where global settings of the image improvement will not be adequate and to find at least one range of values to characterize these regions. For instance, an apparatus for noise reduction in images with optionally grass in it, is not interested in identifying grass, but just determines the probability that a pixel belongs to. Artifacts of noise reduction are the most annoying in some grass textures. The segmentation in that case does not look for every kind of grass but for problematic grass. To detect grass there is more required than just detect green. But if it turns out, e.g. by inspecting the histogram in 116, that the grass region of the image is the only place where green is present, then the only information that must be transmitted to the improvement unit 106 is whether a pixel is green or not. The spatial-based control is then translated to a simple condition-based control.

Another example of a location dependent image improvement apparatus is an apparatus being able to discriminate between foreground and background. This will be explained by means of FIG. 2A and FIG. 2B. FIG. 2A shows an image 200 with a foreground region 204 and background region 202. A selected pixel 222 is indicated. The selected pixel 222 is also depicted in FIG. 2B. FIG. 2B shows a probability space 206 in which the pixels of image 200 are put. The horizontal axis 208 resembles a first property of the pixels of the image 200. The vertical axis 210 resembles a second property of the pixels of the image 200. The value of the first property of the selected pixel 222 is referenced with 230. The value of the second property of the selected pixel 222 is referenced with 226. Suppose it is required to segment the image into a foreground region 204 and a background region 202. In order to segment the image a number of test are applied. For a first test the differences between luminance values of neighboring pixels are calculated and checked whether this difference is in the range of possible values of the first property 212. This means that in this case the first property corresponds to the difference between luminance values of neighboring pixels. For a second test the color value of the pixels is checked. For the selected pixel 222 this second test is a verification whether the value 226 is in the range of possible values of the second property 214. Because the probability to find background 202 in the upper portion of the image 200 is relatively high, the location of the pixels in the image 200 are also used for the segmentation. After performing the tests for all pixels of the image 200 it appears that two sets of pixels can be distinguished in the probability space 206: a first set of pixels 218 and a second set of pixels 220. The first set of pixels 218 can be characterized by using a range of actual values 216 on the axis of the second property. In other words it appears that background pixels and foreground pixels can be separated by means of their color value, for this particular image.

FIG. 3 shows elements of an image display apparatus 300 according to the invention. The image display apparatus 300 has a receiving means 302 for receiving a video signal representing the images to be displayed. The signal may be a broadcast signal received via an antenna or cable but may also be a signal from a storage device like a VCR (Video Cassette Recorder) or DVD (Digital Versatile Disk). The image display apparatus 300 further has an image processing apparatus 100 for processing the video signal and a display device 306 for displaying the images represented by the improved video signal. The image processing apparatus 100 is implemented as described in FIG. 1. The image processing apparatus 100 can be controlled externally. The predetermined ranges of values for the tests in the segmentation unit can be adjusted by means of the control input 126. The receiving means 302 can get notified or has capabilities to extract information from the video signal about the type of scene that has been imaged in order to set the appropriate ranges of predetermined values of the image display apparatus 300. E.g. in the case of a football match a predetermined range of colors should match the colors of grass.

FIGS. 4A, 4B and 4C depict the relation between the actual ranges of values and classification values. FIG. 4A shows a probability space in which the pixels of an image are put after performing a number of tests. The horizontal axis 406 resembles a first property of the pixels of the image. The vertical axis 408 resembles a second property of the pixels of the image. It appears that two sets of pixels can be distinguished in the probability space: a first set of pixels 402 and a second set of pixels 404. The first set of pixels 402 can be characterized by using a range of actual values 216 on the axis of a particular property. A histogram 116 is made of pixels for which the tests were positive. FIG. 4B shows this histogram. The horizontal axis 412 resembles the particular property of the pixels of the image. The vertical axis 410 resembles the number of pixels of the image that satisfy the tests and have a pre-selected value of the particular property. FIG. 4C shows a classification function used to classify the pixels. The classification function shows the classification value as function of value of the particular property. The horizontal axis 416 resembles the particular property of the pixels of the image. The vertical axis 414 resembles the classification value. The maximum classification value 418 corresponds to the center of the actual range 216. The minimum classification value 420 corresponds to the borders of the actual range 216. The classification value varies substantially continuously from the center of the actual range 216 towards the borders of the actual range.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image processing apparatus (100) for improving an image, which image comprises a plurality of pixels, and the image processing apparatus (100) comprising:
a segmentation unit (102) that is designed to perform:
a first test whether a first value (230) of a first property of a selected pixel (222) is substantially equal to a second value (228) of a first predetermined range (212) of values of the first property; and
a second test whether a third value (226) of a second property of the selected pixel (222) is substantially equal to a fourth value (224) of a second predetermined range (214) of values of the second property, in order to segment the image into multiple regions of pixels, each region with a region type; and
an improvement unit (106) that is designed to improve the image by processing a particular pixel, depending on the region type of the region to which the particular pixel corresponds, characterized in comprising a determination unit (104) that is designed to characterize pixels corresponding to regions with a pre-determined region type by determination of an actual range (216) of values of a particular property of the pixels, other than a location; and that the improvement unit (106) processes the pixels corresponding to regions with the pre-determined region type differently.

2. An image processing apparatus (100) as claimed in claim 1, characterized in that the improvement unit (106) is designed to reduce noise in the image.

3. An image processing apparatus (100) as claimed in claim 1, characterized in that the improvement unit (106) is designed to enhance details in the image.

4. An image processing apparatus (100) as claimed in claim 1, characterized in that the first predetermined range (212) of possible values comprises the values related to luminance.

5. An image processing apparatus (100) as claimed in claim 1, characterized in that the first predetermined range (212) of possible values comprises the values related to color.

6. An image processing apparatus (100) as claimed in claim 1, characterized in that the first test is to verify whether a first difference between the first value (230) of the first property of the selected pixel (222) and a sixth value of the neighboring pixel (223) is substantially equal to a seventh value of a third predetermined range of values of the first property.

7. An image processing apparatus (100) as claimed in claim 1, characterized in comprising:
a histogram generating means (114) for generating a histogram (116) of values of the particular property, whereby the histogram comprises pixels for which the first test and the second test are positive; and
an analyzer (118) designed to analyze the histogram (116) in order to determine a classification value of the pixels of the image based on the histogram (116), with the classification value to control the amount of improvement.

8. An image processing apparatus (100) as claimed in claim 7, characterized in that a maximum classification value (418) corresponds to a center of the actual range (216), and a minimum classification value (420) corresponds to a border of the actual range (216), the classification value varying substantially continuously from the center of the actual range (216) towards the border of the actual range.

9. An image processing apparatus (100) as claimed in claim 1, characterized in that the actual range (216) of values comprises the values related to color.

10. An image processing apparatus (100) as claimed in claim 1, characterized in that the actual range (216) of values comprises the values related to luminance.

11. An image processing apparatus (100) as claimed in claim 1, characterized in that the actual range (216) of values comprises values related to a second difference between the particular value of the particular property of the selected pixel (222) and a ninth value of the particular property of the neighboring pixel (223).

12. An image display apparatus (300) provided with:
receiving means (302) for receiving a video signal representing images;
an image processing apparatus (100) for improving an image, which image comprises a plurality of pixels, and the image processing apparatus (100) comprising:
a segmentation unit (102) that is designed to perform:
a first test whether a first value (230) of a first property of a selected pixel (222) is substantially equal to a second value (228) of a first predetermined range (212) of values of the first property; and
a second test whether a third value (226) of a second property of the selected pixel (222) is substantially equal to a fourth value (224) of a second predetermined range (214) of values of the second property,
in order to segment the image into multiple regions of pixels, each region with a region type; and
an improvement unit (106) that is designed to improve the image by processing a particular pixel, depending on the region type of the region to which the particular pixel corresponds; and
a display device (306) for displaying the images, characterized in that the image processing apparatus (100) comprises a determination unit (104) that is designed to characterize pixels corresponding to regions with a predetermined region type by determination of an actual range (216) of values of a particular property of the pixels, other than a location; and that the improvement unit (106) processes the pixels corresponding to regions with the pre-determined region type differently.

13. A method of improving an image, which image comprises a plurality of pixels, and the image processing apparatus (100) comprising:
a segmentation step to perform:
a first test whether a first value (230) of a first property of a selected pixel (222) is substantially equal to a second value (228) of a first predetermined range (212) of values of the first property; and
a second test whether a third value (226) of a second property of the selected pixel (222) is substantially equal to a fourth value (224) of a second predetermined range (214) of values of the second property,
in order to segment the image into multiple regions of pixels, each region with a region type; and
an improvement step to improve the image by processing a particular pixel, depending on the region type of the region to which the particular pixel corresponds, characterized in comprising a determination step to characterize pixels corresponding to regions with a predetermined region type by determination of an actual range (216) of values of a particular property of the pixels, other than a location; and that the improvement unit (106) processes the pixels corresponding to regions with the pre-determined region type differently.
